(19) United States
(12) Patent Application Publication
(10) Pub. No.: US 2026/0054372 A1
(43) Pub. Date: Feb. 26, 2026

(54) PORTABLE PNEUMATIC GENERATOR AND WEARABLE ROBOT INCLUDING SAME

(71) Applicant: KOREA ADVANCED INSTITUTE OF SCIENCE AND TECHNOLOGY, Daejeon (KR)

(72) Inventors: Jung Kim, Daejeon (KR); Ung Heo, Daejeon (KR); Junhwan Choi, Daejeon (KR)

(21) Appl. No.: 19/199,248

(22) Filed: May 5, 2025

(30) Foreign Application Priority Data
Aug. 20, 2024 (KR) 10-2024-0110980

(51) Int. Cl. B25J 9/00; B25J 19/00

(52) U.S. Cl. CPC B25J 9/0006; B25J 19/0025

(57) ABSTRACT

Provided are a portable pneumatic generator and a wearable robot including the same. The portable pneumatic generator includes: a first tank for storing a first reactant; a second tank for storing a second reactant; a reactor for generating a gas by reacting the first reactant with the second reactant; and a reservoir for storing the gas generated by reacting the first reactant with the second reactant and outputting the gas to the outside and storing a residue, wherein the first reactant includes a material used for an exothermic reaction, and the second reactant includes a material used for an endothermic reaction.

### CROSS-REFERENCE TO RELATED APPLICATIONS

This application claims priority under 35 U.S.C. § 119 to Korean Patent Application No. 10-2024-0110980, filed on Aug. 20, 2024, in the Korean Intellectual Property Office, the disclosure of which is incorporated herein by reference in its entirety for all purposes.

### TECHNICAL FIELD

The following disclosure relates to a portable pneumatic generator and a wearable robot including the same.

### BACKGROUND

A wearable robot may mechanically assist a movement of a wearer to enhance a muscle strength of the wearer or assist rehabilitation. Among various actuators for driving the wearable robot, a pneumatic actuator has been widely used due to its high output-to-weight ratio and safety due to its inherent compliance.

However, conventional compressors for generating pneumatic pressure are often bulky and heavy, which limits mobility, and produce significant noise and heat, thereby hindering usability. Micro-compressors have been developed as portable pneumatic generators. However, their noise and heat generation still limit their usability in wearable robot applications.

Accordingly, pneumatic generators based on chemical reactions have been developed. However, this type of generators may cause a failure or threaten user safety due to an intense exothermic reaction. Other approaches using endothermic reactions have also been proposed, but the flow rate capacity of the pneumatic source tends to be low. As a result, incorporating thermal regulation devices to properly control the temperature of the pneumatic generator may complicate the overall system and increase its total weight.

### RELATED ART DOCUMENT

### Patent Document

(Patent Document 1) Korean Patent Laid-Open Publication No. 10-2016-0139595 (published on Dec. 7, 2016)

### SUMMARY

An embodiment of the present disclosure is directed to providing a portable pneumatic generator enabling easy adjustment of a reaction scale and improved safety, and a wearable robot including the same.

Another embodiment of the present disclosure is directed to providing a portable pneumatic generator having uniform pneumatic performance by generating a gas at a constant flow rate Q regardless of pneumatic consumption, and a wearable robot including the same.

Another embodiment of the present disclosure is directed to providing a portable pneumatic generator having a simple and simplified system because no additional electronic device is required, and a wearable robot including the same.

Another embodiment of the present disclosure is directed to providing a portable pneumatic generator producing no acoustic noise, and a wearable robot including the same.

Technical aspects of the present disclosure are not limited to those mentioned above, and other aspects not mentioned here may be clearly understood by those skilled in the art from the following description.

In one general aspect, provided is a portable pneumatic generator including: a first tank for storing a first reactant; a second tank for storing a second reactant; a reactor for generating a gas by reacting the first reactant with the second reactant; and a reservoir for storing the gas generated by reacting the first reactant with the second reactant and outputting the gas to the outside and storing a residue, wherein the first reactant includes a material used for an exothermic reaction, and the second reactant includes a material used for an endothermic reaction.

The first reactant may include an acidic material, and the acidic material may dissociate in the reactor to generate oxonium ions (H₃O⁺) and causes the exothermic reaction.

The second reactant may include bicarbonate, and bicarbonate ions (HCO₃⁻) generated by the bicarbonate may react with the oxonium ions (H₃O⁺) in the reactor to generate carbon dioxide (CO₂) gas and cause the endothermic reaction.

The generator may further include a pressurizing module for pressurizing the interior of the first tank and the interior of the second tank, wherein the pressurizing module pressurizes the interior of the first tank to introduce the first reactant into the reactor, and pressurizes the interior of the second tank to introduce the second reactant into the reactor.

The pressurizing module may include a cartridge for storing high-pressure liquefied carbon dioxide and a regulator for regulating an output pressure of the cartridge.

The reactor may include a coiled tube, and the first reactant and the second reactant may flow along the coiled tube and react with each other continuously.

A tube of the reactor may wrap around the outside of the reservoir in a spiral manner at least a single time.

The generator may further include a back pressure regulator connected to an outlet of the reservoir, wherein the back pressure regulator regulates an internal pressure of the reservoir to be equal to or greater than a predetermined pressure.

The generator may further include a needle valve connected to the first tank or the second tank, wherein the needle valve is capable of regulating a ratio at which the first reactant and the second reactant are injected into the reactor.

The first tank and the second tank may be disposed in a row along a height direction, the second tank may be disposed on top of the first tank, and the reservoir may be disposed to be parallel to the height direction of the first tank or the second tank.

The generator may further include: a first upper housing for fixing the top of the second tank and the top of the reservoir; and a first lower housing for fixing the bottom of the first tank and the bottom of the reservoir.

The generator may further include: a second upper housing spaced apart upward from the first upper housing; and a second lower housing spaced apart downward from the first lower housing, wherein at least one support is disposed between the first upper housing and the second upper housing, and at least one support is disposed between the first lower housing and the second lower housing.

In another general aspect, provided is a wearable robot including the portable pneumatic generator, the robot including: the portable pneumatic generator; a wearable part for mounting the portable pneumatic generator onto a body of a wearer; and a drive part that is driven using a pneumatic pressure of the gas stored in the reservoir of the portable pneumatic generator.

The wearable part may be configured in one of a vest type, a band type, or a suit type, and attached to and detachable from the body of the wearer.

The drive part may assist a movement of at least a part of the body of the wearer.

Other features and aspects will be apparent from the following detailed description, the drawings, and the claims.

### BRIEF DESCRIPTION OF THE DRAWINGS

FIG. 1 is a front perspective view of a portable pneumatic generator according to an embodiment of the present disclosure.

FIG. 2 shows paths in which a first reactant, a second reactant, and a mixture of the first and second reactants are reacted, respectively.

FIG. 3 shows a front perspective view of a portable pneumatic generator according to the embodiment of FIG. 1.

FIG. 4 is a side perspective view of FIG. 3.

FIG. 5 is a schematic diagram of the portable pneumatic generator according to an embodiment of the present disclosure.

FIG. 6 is a graph showing pressure and flow rate diagrams according to an embodiment of the present disclosure, which are confirmed under different pneumatic consumption conditions (1.7 L, 2.8 L, and 3.6 L).

FIG. 7A shows an example of wearing a wearable robot according to an embodiment of the present disclosure, and FIG. 7B shows a temperature of the portable pneumatic generator that is measured when actuating the wearable robot in FIG. 7A.

### DETAILED DESCRIPTION OF EMBODIMENTS

Hereinafter, embodiments of the present disclosure are described with reference to the accompanying drawings. However, these embodiments are provided only as examples, and the present disclosure is not limited to these specific embodiments described as examples.

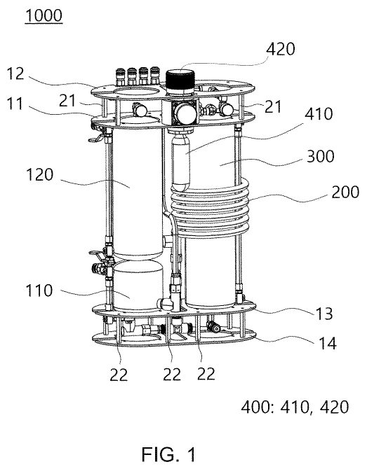

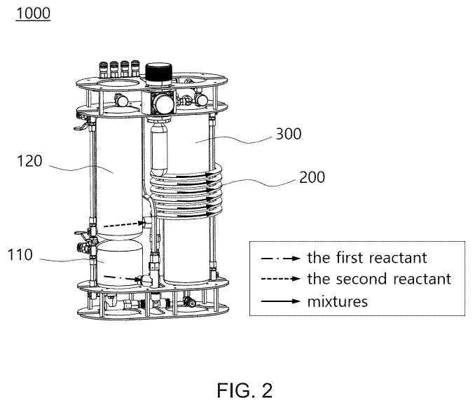

A portable pneumatic generator according to the present disclosure may be applied to a assistive device, a rehabilitation therapy device, a wearable robot, or the like. Hereinafter, a portable pneumatic generator according to an embodiment of the present disclosure is described with reference to FIGS. 1 and 2. FIG. 1 is an overall perspective view of a portable pneumatic generator according to an embodiment of the present disclosure, and FIG. 2 shows paths in which a first reactant, a second reactant, and a mixture of the first and second reactants are reacted, respectively.

According to an embodiment of the present disclosure, a portable pneumatic generator 1000 may include a first tank 110 for storing the first reactant, a second tank 120 for storing the second reactant, a reactor 200 for generating a gas by reacting the first reactant with the second reactant, and a reservoir 300 for storing the gas generated by the reactor 200 and outputting the gas to the outside, and storing a residue. Here, the first reactant may include a material used for an exothermic reaction, and the second reactant may include a material used for an endothermic reaction.

In addition, the portable pneumatic generator 1000 may further include a pressurizing module 400 for pressurizing the interior of the first tank 110 and the interior of the second tank 120 to a predetermined pressure. The pressurizing module 400 may pressurize the interior of the first tank 110 to introduce the first reactant into the reactor 200, and pressurize the interior of the second tank 120 to introduce the second reactant into the reactor 200.

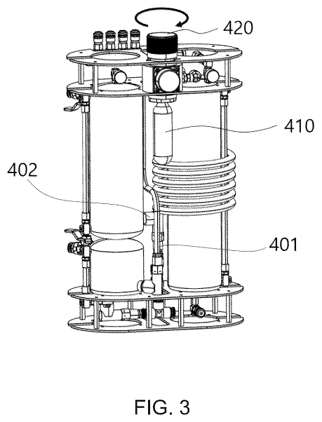

Hereinafter, the pressurizing module 400 is described with reference to FIG. 3. The pressurizing module 400 may include a cartridge 410 for storing high-pressure liquefied carbon dioxide and a regulator 420 for regulating an output pressure of the cartridge 410. By controlling the pressure of the first tank 110 and the second tank 120, the output pressure of the pneumatic generator can be controlled.

Tubes 401 and 402, each connected to the regulator 420, may be installed in the first tank 110 and the second tank 120, and the first tank 110 and the second tank 120 may receive a gas whose pressure is regulated through each tube.

The cartridge 410 may correspond to a small carbon dioxide cartridge for storing the high-pressure liquefied carbon dioxide, and may be mounted in a detachable manner for replacement. The regulator 420 is intended to stably regulate a high-pressure gas output from the cartridge 410, and may reduce an output pressure of the cartridge 410 to a predetermined pressure.

In detail, a knob of the regulator 420 may be manipulated to regulate the output pressure of the cartridge 410, thereby pressurizing the interior of the first tank 110 and the interior of the second tank 120 to the predetermined pressure. Meanwhile, a check valve may be further installed in the tube 401 or 402, and the first tank 110 or the second tank 120 may be pressurized to a predetermined pressure P1 through each check valve.

Hereinafter, the first tank 110 is described by referring back to FIG. 2. The first tank 110 may provide a space for storing the first reactant. The first tank 110 may have a cylindrical vessel shape, and be made of a material such as carbon steel, stainless steel, aluminum alloy, or titanium alloy.

If an internal pressure of the first tank 110 is higher than an internal pressure of the reactor 200, the first reactant may be transferred from the first tank 110 to the reactor 200 (see a dashed-dotted arrow in FIG. 2). A transfer tube may be further installed in one side of the first tank 110 to transfer the first reactant from the first tank 110 to an inlet of the reactor 200.

The first tank 110 may further include an inlet for injecting the first reactant into the first tank 110 and an outlet for discharging the first reactant to the outside of the first tank 110. For example, when a remaining amount of the first reactant is small or non-existent, the first reactant may be injected into the first tank 110 through the inlet. In addition, when the remaining amount of the first reactant is large, the first reactant may be discharged to the outside of the first tank 110 through the outlet. A level gauge may be installed on one side of the first tank 110 to check the remaining amount of the first reactant in the first tank 110.

Hereinafter, the second tank 120 is described. The second tank 120 may provide a space for storing the second reactant. Similar to the first tank, the second tank 120 may also have a cylindrical vessel shape, and be made of the material such as carbon steel, stainless steel, aluminum alloy, or titanium alloy.

Similar to the first tank, if an internal pressure of the second tank 120 is higher than the internal pressure of the reactor 200, the second reactant may be transferred from the second tank 120 to the reactor 200 (see a dotted arrow in FIG. 2). A transfer tube for transferring the second reactant from the second tank 120 to the inlet of the reactor 200 may be further installed in one side of the second tank 120. A check valve 111 or 121 may be installed in each transfer tube. The check valve 111 or 121 may prevent the reactant from flowing back into the first tank 110 or the second tank 120 by allowing the first reactant or the second reactant to flow toward the reactor 200.

The transfer tube installed in the first tank 110 and the transfer tube transferred to the second tank 120 may meet each other at a front end of the reactor 200 to mix the first reactant with the second reactant. That is, the first reactant and the second reactant may be mixed with each other at the inlet of the reactor 200, and then transferred along a tube of the reactor 200 to proceed with a chemical reaction (see a solid arrow in FIG. 2). The chemical reaction in the reactor 200 is described below.

Meanwhile, the first tank 110 and the second tank 120 may be disposed in a row along a height direction, and the second tank 120 may be disposed on top of the first tank 110. Here, diameters of the first tank 110 and the second tank 120 may be equal or similar to each other, which may be preferable in terms of space usability. However, heights of the first tank 110 and the second tank 120 may be configured to be different from each other, and volumes of the first tank 110 and the second tank 120 may thus be appropriately designed and changed, thereby allowing an appropriate amount of reactant to be stored inside each tank.

Similar to the first tank 110, the second tank 120 may also include an inlet and an outlet, and a level gauge may be installed on one side of the second tank 120 to check a remaining amount of the second reactant.

Hereinafter, the reactor 200 is described. The reactor 200 may be a facility that performs the chemical reaction between the first reactant and the second reactant, and the first reactant and the second reactant may produce a material (hereinafter, referred to as a product) different from the first reactant and the second reactant through the chemical reaction in the reactor 200.

The reactor 200 may be configured as a flow reactor. The reactor 200 may continuously flow the first reactant and the second reactant inside the tube of the reactor 200 to allow the continuous chemical reaction to occur continuously. Unlike a batch reactor in which the reactants are added simultaneously to acquire the product, the present disclosure adopts the flow reactor to easily regulate the reaction scale, improve safety, and easily optimize a reaction condition.

In addition, the above-mentioned batch reactor inevitably requires an additional electronic device (e.g., electronic valve, stirring device, or sensor) for controlling the reaction, which may complicate the system. According to an embodiment of the present disclosure, the portable pneumatic generator having a simple and simplified system may be provided because the aforementioned additional electronic device is not required.

In detail, the reactor 200 may include a coiled tube in which the tube is formed in a plurality of spiral shapes. According to an embodiment of the present disclosure, the first reactant and the second reactant may react with each other while moving along the coiled tube having a high surface area, thereby improving the mixing efficiency and reaction efficiency of the reactants.

Meanwhile, the coiled tube may be a tube wrapping around the outside of the reservoir 300 in a spiral manner while having the reservoir 300 as its center. According to the present disclosure, the coiled tube may wrap around the outside of the reservoir 300 in the spiral manner at least a single time, thereby optimizing the space usability and reducing an overall volume of the portable pneumatic generator.

Hereinafter, the chemical reaction in the reactor 200 is described in detail.

According to an embodiment of the present disclosure, the first reactant may include the material used for an exothermic reaction, and the second reactant may include the material used for an endothermic reaction.

In detail, the first reactant may include an acidic material, and the acidic material included in the first reactant may dissociate in the reactor 200 to generate oxonium ions (H₃O⁺) and cause the exothermic reaction (hereinafter, referred to as a first stage). The second reactant may include bicarbonate, and bicarbonate ions (HCO₃) generated by dissolving bicarbonate may react with the oxonium ions (H₃O⁺) in the reactor 200 to generate a carbon dioxide (CO₂) gas and cause the endothermic reaction (hereinafter, referred to as a second stage).

The first stage and the second stage described above may be expressed by chemical reaction formulas as follows.

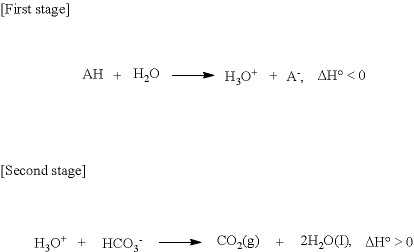

AH in the first stage indicates the acidic material to provide the oxonium ions (H₃O⁺), and acids corresponding to the exothermic reaction in a dissociation reaction may correspond thereto. For example, AH may correspond to one acid selected from the group of phosphoric acid (H₃PO₄), hydrochloric acid (HCl), and sulfuric acid (H₂SO₄). The first stage in which the acidic material dissociates may correspond to the exothermic reaction. However, from a safety perspective, it may be preferable to select phosphoric acid, which is classified as a weak acid, as the acidic material.

A material that provides the bicarbonate ions (HCO₃—) in the second stage may correspond to the bicarbonate. For example, this material may correspond to one bicarbonate selected from the group of sodium bicarbonate (NaHCO₃), potassium bicarbonate (KHCO₃), and cesium bicarbonate (CsHCO₃). The oxonium ions (H₃O⁺) generated in the first stage may react with the bicarbonate ions in the second stage, thereby generating the carbon dioxide gas and the residue. The second stage, in which carbon dioxide gas is generated, may correspond to the endothermic reaction.

As described above, according to an embodiment of the present disclosure, the first reactant may include the material used for an exothermic reaction, and the second reactant may include the material used for an endothermic reaction. Therefore, in the reactor 200, the first stage corresponding to the exothermic reaction and the second stage corresponding to the endothermic reaction may occur repeatedly and continuously. That is, according to the present disclosure, the endothermic reaction and the exothermic reaction may be integrated to offset an endothermic heat amount and an exothermic amount to thus minimize a total sum of enthalpy changes, thereby providing the portable pneumatic generator having a low exothermic property.

In addition, according to an embodiment of the present disclosure, the gas may be generated using the chemical reaction, and a mechanical compression mechanism such as a compressor is not used, thus causing minimized acoustic noise.

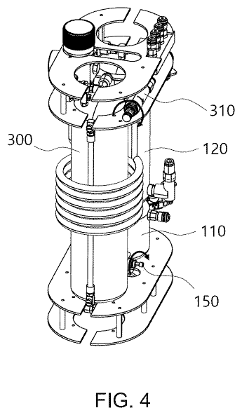

Meanwhile, a needle valve 150 capable of regulating a ratio r at which the first reactant and the second reactant are injected into the reactor 200 may be installed at an outlet of the first tank 110 or the second tank 120. As shown in FIG. 4, the needle valve 150 may be manipulated to perform the regulation for one specific reaction among the endothermic reaction and the exothermic reaction to become dominant, thereby regulating a total exothermic amount. Thus, the reaction ratio can be adjusted by manipulating the needle valve 150, and as a result, the temperature of the pneumatic generator can be controlled.

Hereinafter, the reservoir300 is described. The reservoir 300 may provide a space for storing the gas and residue generated by the reaction of the first reactant with the second reactant in the reactor 200. Similar to the first tank 110 and the second tank 120, the reservoir 300 may also have a cylindrical vessel shape, and be made of the material such as carbon steel, stainless steel, aluminum alloy, or titanium alloy.

The first reactant and the second reactant may react with each other to generate the gas. For example, if the first reactant includes the acidic material and the second reactant includes the bicarbonate, the gas generated by the reaction between the first reactant and the second reactant may correspond to the carbon dioxide gas. The reservoir 300 may store the gas generated by the reaction of the first reactant with the second reactant as compressed gas, and may release the compressed gas to a place where a pneumatic pressure is required.

The reservoir 300 may be configured to be larger than the volumes of the first tank 110 and the second tank 120 to sufficiently accommodate the generated gas. In detail, a diameter of the reservoir 300 may be equal or similar to the diameters of the first tank 110 and the second tank 120, and a height of the reservoir 300 may be greater than the height of the first tank 110 and the height of the second tank 120. Here, the first tank 110 and the second tank 120, which have relatively small volumes compared to that of the reservoir 300, may be disposed in a row along the height direction, and the reservoir 300 may be disposed to be parallel to side surfaces of the first tank 110 and the second tank 120 along the height directions of the first tank 110 and the second tank. Such a layout relationship may be preferable in configuring a compact overall size of the portable pneumatic generator 1000.

In detail, the first tank 110 and the second tank 120 may be disposed in a row along the height direction, the second tank 120 may be disposed on top of the first tank 110, and the reservoir 300 may be disposed to be parallel to the height direction of the first tank 110 or the second tank 120. Here, the portable pneumatic generator 1000 may further include a first upper housing 11 for simultaneously fixing the top of the second tank 120 and the top of the reservoir 300 and a first lower housing 13 for simultaneously fixing the bottom of the first tank 110 and the bottom of the reservoir 300.

The portable pneumatic generator 1000 may further include a second upper housing 12 spaced apart upward from the first upper housing 11 and a second lower housing 14 spaced apart downward from the first lower housing 13. At least one support 21 may be disposed between the first upper housing 11 and the second upper housing 12, and at least one support may also be disposed between the first lower housing 13 and the second lower housing 14. The check valve, the needle valve, an elbow fitting for pipe connection, a T-shaped pipe, a manifold, and other components may be disposed in a space between the first upper housing and the second upper housing spaced apart from each other, and a space between the first lower housing and the second lower housing spaced apart from each other.

A back pressure regulator 310 may be installed at an outlet of the reservoir 300. As shown in FIG. 4, the back pressure regulator 310 may manipulate its knob to thus regulate an internal pressure P3 of the reservoir 300 not to fall to a predetermined pressure value Ps or below. Here, the pressurizing module 400 may pressurize the first tank 110 and the second tank 120 so that the internal pressure P1 of the first tank 110 or the second tank 120 is greater than the predetermined pressure value Ps of the reservoir 300. Thus, the output flow rate of the pneumatic generator can be adjusted by manipulating the knob of the back pressure regulator 310.

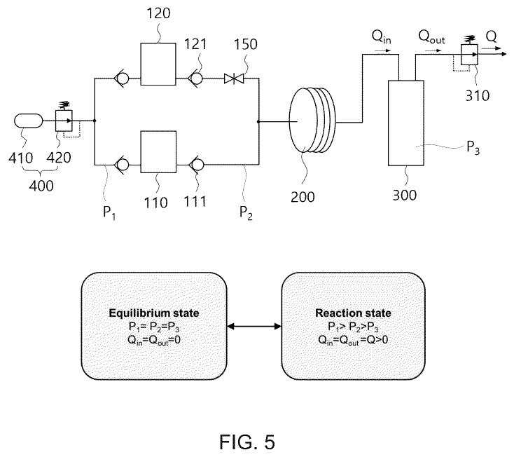

Hereinafter, referring to FIG. 5, a reaction state and an equilibrium state according to an embodiment of the present disclosure are described. When the gas in the reservoir 300 is consumed and the internal pressure P3 of the reservoir 300 becomes less than the internal pressure P1 of the first tank 110 or the second tank 120, the first reactant and the second reactant may be spontaneously injected into the reactor 200 due to a pressure difference (hereinafter, referred to as the reaction state).

The injected first reactant and second reactant may react with each other to generate the gas, and this process may continuously proceed until the internal pressure P3 of the reservoir 300 becomes equal to the internal pressure P1 of the first tank 110 or the second tank 120. When the internal pressure P3 and the internal pressure P1 become equal to each other, the injection of the first reactant and the second reactant may be stopped, thus spontaneously transitioning to the equilibrium state.

That is, according to the present disclosure, the transition between the equilibrium state and the reaction state may occur spontaneously based on the gas consumption in the reservoir 300 without any intervention of the electronic device (e.g., valve or sensor), thereby providing the pneumatic generator having a simplified system.

Meanwhile, the difference between the internal pressure P3 of the reservoir 300 and the internal pressure P1 of the first tank 110 or the second tank 120 may be maintained at a constant level by using the back pressure regulator 310 and the pressurizing module 400, thereby achieving a steady-state reaction in which an aspect of the reaction occurring in the reactor 200 is maintained at a constant level. In the case of the steady-state reaction, the injection flow rate and injection ratio of the first reactant to the second reactant, as well as the flow rate Q of the generated gas, may be maintained to be constant. That is, according to an embodiment of the present disclosure, the portable pneumatic generator having a uniform pneumatic performance may be provided by generating the gas at the constant flow rate Q regardless of the pneumatic consumption discharged from the reservoir 300.

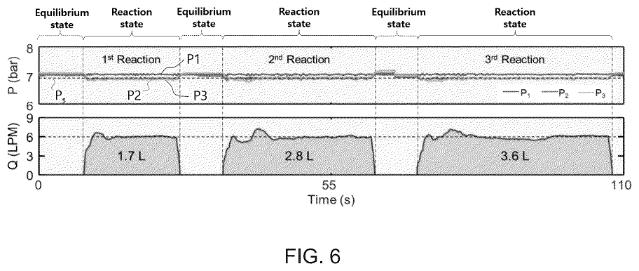

FIG. 6 is a graph showing pressure and flow rate diagrams according to an embodiment of the present disclosure, which are confirmed under different pneumatic consumption conditions (1.7 L, 2.8 L, and 3.6 L). It may be confirmed that the difference between P1 and P3 is maintained to be constant regardless of the pneumatic consumption, and the gas generation flow rate Q is also maintained to be constant at an average of 6 liters per minute (LPM). In this way, according to the present disclosure, the portable pneumatic generator having the uniform pneumatic performance may be provided regardless of the pneumatic consumption, and thus be universally applied to various pneumatic generators.

In addition, it may be confirmed that when the pneumatic pressure is consumed, P3 becomes lower than P1, which causes the transition from the equilibrium state to the reaction state, and the gas is generated at the constant flow rate Q. This configuration indicates that the first reactant and the second reactant are introduced into the reactor and the reaction proceeds. In addition, it may be confirmed that if the pneumatic pressure is not consumed, P3 and P1 become equal to each other, and the transition occurs from the reaction state to the equilibrium state and no gas is generated. This configuration indicates that P3 and P1 become equal to each other, the first reactant and the second reactant are not introduced into the reactor, and the chemical reaction does not proceed. In this way, according to the present disclosure, the transition between the equilibrium state and the reaction state may occur spontaneously based on the gas consumption in the reservoir 300 without any intervention of the electronic device (e.g., valve or sensor), thereby providing the pneumatic generator having a simplified system.

Hereinafter, the wearable robot including the portable pneumatic generator is described. The description omits a content overlapping the description of the portable pneumatic generator according to an embodiment of the present disclosure described above.

A wearable robot 2000 according to an embodiment of the present disclosure may include the portable pneumatic generator 1000, a wearable part for mounting the portable pneumatic generator onto a body of a wearer, and a drive part that moves using a pneumatic pressure of the gas stored in the reservoir 300 of the portable pneumatic generator.

The wearable part may be configured in one of a vest type, a band type, and a suit type, and may be attached to and detached from the body of the wearer.

The drive part may assist a movement of at least a part of the body of the wearer. For example, the drive part may correspond to an elbow exosuit for assisting a forearm of the wearer, and as another example, the drive part may correspond to a pneumatic glove for assisting a hand of the wearer that holds an object.

As a result of manufacturing a prototype of the portable pneumatic generator according to an embodiment of the present disclosure, a weight of each component is as shown in [Table 1] below, and it may be confirmed that a total weight of the portable pneumatic generator is 2.5 kg.

TABLE 1

| Component | Mass(kg) |
|---|---|
| First tank | 0.4 |
| Second tank | 0.2 |
| Reservoir | 0.6 |
| Pressurizing module | 0.4 |
| Back pressure regulator | 0.1 |
| Housing and support | 0.2 |
| Fitting and tubing | 0.6 |
| Total | 2.5 |

In the case of the prototype, 1.4 kg of the reactants may be loaded, and it is confirmed that the pneumatic gloves may be driven approximately 632 times with 1.4 kg of fuel.

According to an embodiment of the present disclosure, the portable pneumatic generator may be made lightweight to facilitate wearing of the wearable robot 2000. Furthermore, the total weight of the portable pneumatic generator may be further reduced compared to a prototype manufactured based on the weight reduction of the first tank 110, the second tank 120, and the reservoir 300, and customization of parts, which may provide the wearable robot 2000 having improved usability. In addition, even if the portable pneumatic generator is used, it can still supply a sufficient pneumatic flow rate, thereby extending the operating time of the wearable robot. In addition, the portable pneumatic generator having the low exothermic property may enhance user safety of the wearable robot.

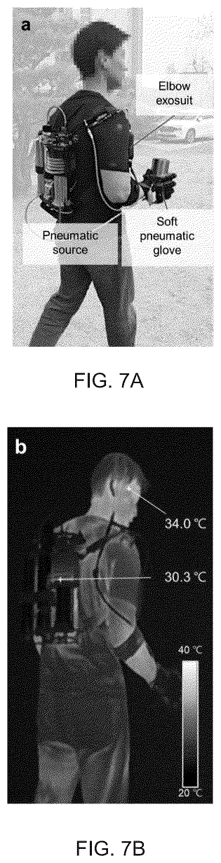

FIG. 7A shows an example of wearing the wearable robot according to an embodiment of the present disclosure, and shows a portable pneumatic module worn on a shoulder of the wearer like a backpack using the wearable part configured in the vest type. FIG. 7B shows a temperature of the portable pneumatic generator that is measured when driving the wearable robot in FIG. 7A. It may be confirmed that the temperature of the portable pneumatic generator is 30.3° C. when the output pressure P3 of the portable pneumatic generator is set to 7 bar and the output flow rate Q is set to 6 LPM, which indicates that the temperature is within a range similar to a human body temperature.

The portable pneumatic generator according to an embodiment of the present disclosure may easily regulate the reaction scale and improve the safety.

In addition, the portable pneumatic generator according to an embodiment of the present disclosure may have the uniform pneumatic performance by generating the gas at the constant flow rate Q regardless of the pneumatic consumption, and may thus be universally applied to the various wearable robots.

In addition, the portable pneumatic generator according to an embodiment of the present disclosure may simplify the system because no additional electronic device is required.

In addition, the portable pneumatic generator and the wearable robot according to the embodiments of the present disclosure may minimize the noise generation.

Advantageous effects of the present disclosure are not limited to those mentioned above, and other effects not mentioned here may be clearly understood by those skilled in the art from the above description.

The embodiments of the present disclosure have been described hereinabove with reference to the accompanying drawings. However, it should be understood by those skilled in the art to which the present disclosure pertains that various modifications and alterations may be made without departing from the technical spirit or essential feature of the present disclosure. Therefore, it should be understood that the embodiments described hereinabove are illustrative rather than restrictive in all respects.

What is claimed is:

1. A portable pneumatic generator comprising:
a first tank for storing a first reactant;
a second tank for storing a second reactant;
a reactor for generating a gas by reacting the first reactant with the second reactant; and
a reservoir for storing the gas generated by reacting the first reactant with the second reactant and outputting the gas to the outside and storing a residue,
wherein the first reactant includes a material used for an exothermic reaction, and
wherein the second reactant includes a material used for an endothermic reaction.

2. The generator of claim 1, wherein the first reactant includes an acidic material, and
wherein the acidic material dissociates in the reactor to generate oxonium ions (H₃O⁺) and causes the exothermic reaction.

3. The generator of claim 2, wherein the second reactant includes bicarbonate, and bicarbonate ions (HCO₃⁻) generated by the bicarbonate react with the oxonium ions (H₃O⁺) in the reactor to generate carbon dioxide (CO₂) gas and cause the endothermic reaction.

4. The generator of claim 1, further comprising a pressurizing module for pressurizing an interior of the first tank and an interior of the second tank,
wherein the pressurizing module pressurizes the interior of the first tank to introduce the first reactant into the reactor, and pressurizes the interior of the second tank to introduce the second reactant into the reactor.

5. The generator of claim 4, wherein the pressurizing module includes:
a cartridge for storing high-pressure liquefied carbon dioxide, and
a regulator for regulating an output pressure of the cartridge.

6. The generator of claim 4, wherein the reactor includes a coiled tube, and
wherein the first reactant and the second reactant flow along the coiled tube and react with each other continuously.

7. The generator of claim 6, wherein the coiled tube of the reactor wraps around the outside of the reservoir in a spiral manner at least a single time.

8. The generator of claim 5, further comprising a back pressure regulator connected to an outlet of the reservoir,
wherein the back pressure regulator regulates an internal pressure of the reservoir to be equal to or greater than a predetermined pressure.

9. The generator of claim 1, further comprising a needle valve connected to the first tank or the second tank,
wherein the needle valve is capable of regulating a ratio at which the first reactant and the second reactant are injected into the reactor.

10. The generator of claim 1, wherein the first tank and the second tank are disposed in a row along a height direction,
wherein the second tank is disposed on top of the first tank, and
wherein the reservoir is disposed to be parallel to the height direction of the first tank or the second tank.

11. The generator of claim 10, further comprising:
a first upper housing for fixing a top of the second tank and a top of the reservoir; and
a first lower housing for fixing a bottom of the first tank and a bottom of the reservoir.

12. The generator of claim 11, further comprising:
a second upper housing spaced apart upward from the first upper housing; and
a second lower housing spaced apart downward from the first lower housing,
wherein at least one support is disposed between the first upper housing and the second upper housing, and
wherein at least one support is disposed between the first lower housing and the second lower housing.

13. A wearable robot including the portable pneumatic generator of claim 1, the robot comprising:
the portable pneumatic generator,
a wearable part for mounting the portable pneumatic generator onto a body of a wearer; and
a drive part that is driven using a pneumatic pressure of the gas stored in the reservoir of the portable pneumatic generator.

14. The robot of claim 13, wherein the wearable part is configured in one of a vest type, a band type, or a suit type, and
wherein the wearable part is attached to and detachable from the body of the wearer.

15. The robot of claim 13, wherein the drive part assists a movement of at least a part of the body of the wearer.
